(19) United States
(12) Patent Application Publication
(10) Pub. No.: US 2004/0140762 A1
(43) Pub. Date: Jul. 22, 2004

(54) Organic EL device and method for producing the same

(75) Inventors: Teruo Tohma, Yamagata (JP); Michio Menda, Yamagata (JP); Masami Kimura, Yamagata (JP)

Correspondence Address: SUGHRUE MION, PLLC, 2100 PENNSYLVANIA AVENUE, N.W., SUITE 800, WASHINGTON, DC, 20037, US

(73) Assignee: TOHOKU PIONEER CORPORATION

(21) Appl. No.: 10/751,632

(22) Filed: Jan. 6, 2004

(30) Foreign Application Priority Data
Jan. 14, 2003 (JP) P2003-005442

(51) Int. Cl. H01J 1/62

(52) U.S. Cl. 313/506

(57) ABSTRACT

In an organic EL device having a lower electrode, an upper electrode, and an organic light-emitting functional layer provided between the lower and upper electrodes and containing at least a light-emitting layer, the organic EL device formed on a substrate is sealed with a transparent passivation film and a color filter is provided on the passivation film. The organic EL device can be formed thinly. In an active drive type organic EL device having a TFT provided between the substrate and the organic light-emitting functional layer, the color filter can be set after the organic EL device is sealed with the passivation film. In addition to improvement in numerical aperture and contrast, deterioration of the color filter caused by a high-temperature process for production of the TFT can be avoided.

### BACKGROUND OF THE INVENTION

1. Field of the Invention

The present invention relates to an organic EL device used in a display unit.

2. Description of the Related Art

An organic EL device has been researched eagerly in recent years. When full color display is to be achieved by a display unit using this type organic EL device, there is generally used a method in which an organic light-emitting functional layer for emitting light of RGB respectively is produced by side-by-side deposition of RGB emitting materials (individual patterning method), a method in which a color filter is combined with an organic light-emitting functional layer for emitting monochromatic light of white (color filter method), a method in which a fluorescent color conversion layer is combined with an organic light-emitting functional layer for emitting monochromatic light of blue or white (fluorescent color conversion method), or a method in which electromagnetic wave is applied on a light-emitting area of an organic light-emitting functional layer for emitting monochromatic light to thereby achieve light with a plurality of colors (photobleaching method), or the like.

Of the methods for achieving full color display, the color filter method or the fluorescent color conversion method is excellent in that full color display can be achieved by patterning the color filter or the fluorescent color conversion layer containing fluorescent substances as well as the production method is simple and inexpensive because it can be provided by a single organic light-emitting functional layer. Light emitted from the organic light-emitting functional layer 120 is extracted from a surface opposite to the substrate 100, as disclosed in JP-A-2000-195670. This is because the color filter layer and the fluorescent color conversion layer (layers for changing the color of emitted light by a function of shifting the wavelength of light emitted from the organic light-emitting functional layer to the long wavelength side or by a function of selecting the wavelength of emitted light are hereinafter generically referred to as color filter 150) need not be provided between the substrate 100 and the organic light-emitting functional layer 120, because a transparent substrate need not be provided as the substrate 100 or because there is no problem that extraction efficiency is lowered due to the transparent substrate.

Particularly in the case of an organic EL device using not a passive drive method but an active drive method based on combination of a thin-film transistor and an organic light-emitting functional layer, there is a limitation that the thin-film transistor (hereinafter referred to as TFT 201) below the organic light-emitting functional layer must be reduced as extremely as possible so that the TFT 201 does not block light emitted from the organic light-emitting functional layer. When the TFT 201 is formed on the color filter, there is the possibility that the color filter may be damaged by a high-temperature process for production of the TFT 201. To avoid the damage of the color filter, in the organic EL-device using an active drive method, emitted light is extracted from a surface opposite to the substrate 200 (see JP-A-11-339968)

### SUMMARY OF THE INVENTION

According to the invention described in JP-A-2000-195670, a lower electrode 110, the organic light-emitting functional layer 120, an upper electrode 130 and the color filter 150 are provided successively on the substrate 100, and a transparent intrusion preventing layer 140 is formed for preventing constituent compounds of the color filter 150 from intruding into the organic light-emitting functional layer 120. Water, oxygen, etc. from the outside of the organic EL device, however, may be considered as another cause of deterioration of the organic light-emitting functional layer. Accordingly, in the configuration of JP-A-2000-195670, there is a disadvantage that means for sealing the organic EL device must be provided separately (see FIG. 1).

On the other hand, in the active drive type organic EL device having TFTs 201 provided on the substrate 200 as described in JP-A-11-339968, a lower electrode 210, an organic light-emitting functional layer 220 and an upper electrode 230 are provided successively on each TFT 201. When the organic EL device is then sealed with a sealing substrate 240 including color filters 250, there is a problem that the organic EL device becomes thick as a whole because of the distance formed in the space between each organic light-emitting function layer 220 and a corresponding color filter 250, and that light emitted from the organic EL device becomes blur to bring lowering of contrast (see FIG. 2).

Therefore, an object of the invention is to provide a thin organic EL device in which both provision of an effective sealing unit and improvement of contrast can be attained.

To achieve the foregoing object, the invention provides an organic EL device including a lower electrode, an upper electrode, an organic light-emitting functional layer provided between the lower and upper electrodes and containing at least a light-emitting layer, and a transparent passivation film for sealing the lower and upper electrodes and the organic light-emitting functional layer, wherein the organic EL device further includes a color filter provided above the passivation film.

The invention also provides an organic EL device including a substrate, a lower electrode provided on the substrate, an upper electrode, an organic light-emitting functional layer provided between the lower and upper electrodes and containing at least a light-emitting layer, and a transparent passivation film for sealing the lower and upper electrodes and the organic light-emitting functional layer, wherein the organic EL device further includes a color filter provided on the passivation film so that light is extracted from a surface opposite to the substrate.

The invention further provides a method of producing an organic EL device including a lower electrode, an upper electrode, and an organic light-emitting functional layer provided between the lower and upper electrodes and containing at least a light-emitting layer, the method including the steps of: sealing the organic EL device with a transparent passivation film; and providing a color filter on the passivation film.

The invention further provides a method of producing an organic EL device including a substrate, a lower electrode provided on the substrate, an upper electrode, and an organic light-emitting functional layer provided between the lower and upper electrodes and containing at least a light-emitting layer, the method including the steps of: sealing the organic EL device with a transparent passivation film; and providing a color filter on the passivation film.

### BRIEF DESCRIPTION OF THE DRAWING

FIG. 1 is an explanatory view of an organic EL device in the related art (JP-A-2000-195670).

FIG. 2 is an explanatory view of an organic EL device in the related art (JP-A-11-339968).

FIG. 3 is an explanatory view showing a first embodiment of the invention.

FIGS. 4A to 4C-are explanatory views concerning a color filter in the first embodiment.

FIGS. 5A to 5F are explanatory views concerning alignment of the color filter in the first embodiment.

FIG. 6 is an explanatory view showing a second embodiment of the invention.

FIG. 7 is an explanatory view showing a third embodiment of the invention.

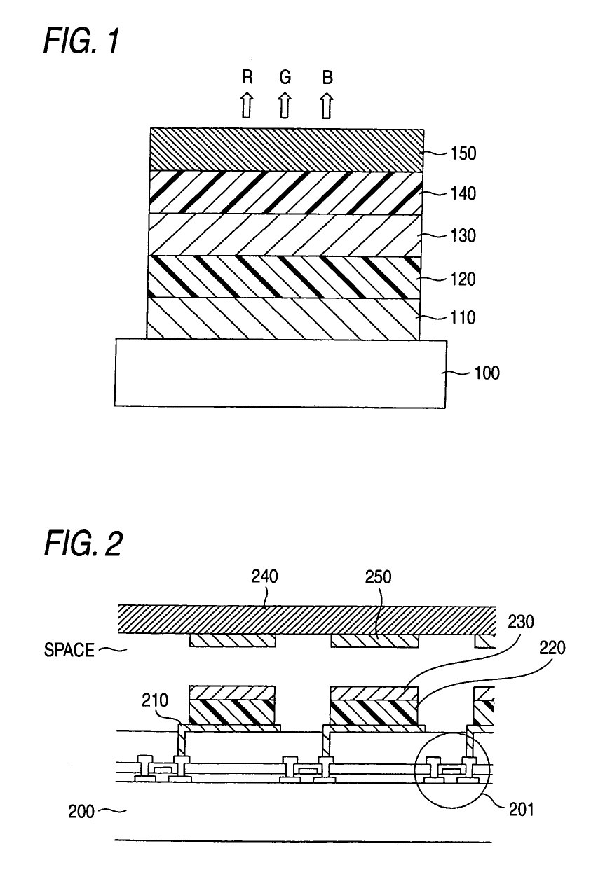

### DETAILED DESCRIPTION OF THE PREFERRED EMBODIMENTS

The structure of an organic EL device, the materials used for producing the organic EL device and the method for producing the organic EL device will be described below. However, the invention is not particularly limited to the following embodiments but may be changed suitably in terms of design according to the purpose of use of the organic EL device. All the changes may be used in the invention.

### First Embodiment

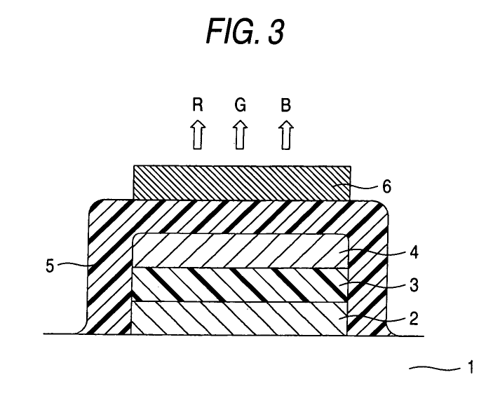

A first embodiment of the invention will be described with reference to FIG. 3. After a lower electrode 2, an organic light-emitting functional layer 3 and an upper electrode 4 are laminated successively above a substrate 1, the layer 3 and the electrodes 2 and 4 are sealed with a transparent passivation film 5. After the sealing step, a color filter 6 is provided above the passivation film 5. In this manner, a thin organic EL device can be produced.

The shape of the substrate 1 is not particularly limited. For example, a planar shape, a film shape, or a spherical shape may be used. Glass, plastic, quartz, metal, etc. may be used as the material of the substrate 1. Particularly in an organic EL device of the type for extracting light from a surface opposite to the substrate 1, it does not matter whether the substrate 1 is transparent or not. Glass or transparent plastic may be preferably used as the transparent material of the substrate 1.

It does not matter whether either of the lower and upper electrodes 2 and 4 is used as a cathode or as an anode. At least the upper electrode 4 is preferably made of a transparent material. The anode is made of a material higher in work function than the material of the cathode. A film of a metal such as chromium (Cr), molybdenum (Mo), nickel (Ni) or platinum (Pt) or a film of a transparent electric conductor such as indium oxide (In₂O₃), ITO or IZO may be used as the anode. On the other hand, the cathode is made of a material lower in work function than the material of the anode. A film of a metal such as aluminum (Al) or magnesium (Mg), an amorphous semiconductor such as doped polyaniline or doped polyphenylene-vinylene or an oxide such as Cr₂O₃, NiO or Mn₂O₅ may be used as the cathode. Each of the lower and upper electrodes 2 and 4 may be made of a transparent material and a reflecting film may be provided on the electrode side opposite to the light emitting side. Preferably, a reflecting film may be provided between the substrate 1 and the lower electrode 2 so that the organic EL device is provided as a device for emitting light from an upper surface.

The lower electrode 2 is formed as a thin film on the substrate 1 by a method such as vapor deposition or sputtering and patterned into a required shape by photolithography or the like. The organic light-emitting functional layer 3 is formed so as to be sandwiched between the lower and upper electrodes 2 and 4 which are paired with each other. Several lines of the upper electrode 4 are formed so as to be perpendicular to several striped lines of the lower electrode 2 so that the lower and upper electrodes 2 and 4 form a matrix. The upper electrode 4 is formed as a thin film by a method such as vapor deposition or sputtering.

A combination of a hole transport layer, a light-emitting layer and an electron transport layer is generally used as the organic light-emitting functional layer 3. Each of the light-emitting layer, the hole transport layer and the electron transport layer may be provided as a single layer or may be provided as a laminate of a plurality of layers. Either or both of the hole transport layer and the electron transport layer may be dispensed with. An organic functional layer such as a hole injection layer or an electron injection layer may be inserted in the organic light-emitting functional layer 3 according to the purpose of use.

Any material selected from known compounds in the related art can be used as the material of the hole transport layer if the hole transport layer has a function high in hole mobility. Specific examples of the material of the hole transport layer include: porphyrin compounds such as copper phthalocyanine; aromatic tertiary amine such as 4,4′-bis[N-(1-naphthyl)-N-phenylamino]-biphenyl (NPB); stilbene compounds such as 4-(di-P-tolylamino)-4′-[4-(di-P-tolylamino)styryl]stilbene zene; and organic materials such as triazole derivatives and styrylamine compounds. A high-molecular dispersion material prepared by dispersing a low-molecular hole transport organic material into a high-molecular material such as polycarbonate may be also used as the material of the hole transport layer.

Any known light-emitting material can be used as the material of the light-emitting layer. Specific examples of the material of the light-emitting layer may include: aromatic dimethylidyne compounds such as 4,4′-bis(2,2′-diphenylvinyl)-biphenyl (DPVBi); styrylbenzene compounds such as 1,4-bis(2-methylstyryl)benzene; triazole derivatives such as 3-(4-biphenyl)-4-phenyl-5-t-butylphenyl-1,2,4-triazole (TAZ); fluorescent organic materials such as anthraquinone derivatives and fluorenone derivatives; fluorescent organometallic compounds such as (8-hydroxyquinolinate) aluminum complex (Alq3); high-molecular materials such as polyparaffinylene-vinylene (PPV) compounds, polyfluorene compounds and polyvinylcarbazole (PVK) compounds; and organic materials capable of using phosphorescence from triplet excitons such as platinum complex or iridium complex for emitting light. The light-emitting layer may be made of only the aforementioned light-emitting material. Or the light-emitting layer may contain a hole transport material, an electron transport material, an additive (such as a donor or an acceptor), a luminous dopant, etc. These may be dispersed in a high-molecular material or an inorganic material.

Any material selected from known compounds in the related art can be used as the material of the electron transport layer if the electron transport layer has a function for transmitting electrons injected from the cathode to the light-emitting layer. Specific examples of the material of the electron transport layer include: organic materials such as nitrated fluorenone derivatives and anthraquinodimethane derivatives; metal complex such as 8-quinolinol derivatives; and metal phthalocyanine.

The materials of the hole transport layer, the light-emitting layer and the electron transport layer are not limited to the aforementioned materials but may be selected suitably. Each of the hole transport layer, the light-emitting layer and the electron transport layer may be formed by a wet process such as a coating method (e.g. a spin coating method or a dipping method) or a printing method (e.g. an ink jet method or a screen printing method) or by a dry process such as a vapor deposition method or a laser transfer method.

The passivation film 5 may be provided as a single layer, a laminate of a plurality of layers or a film formed by coating if the passivation film 5 is transparent. The thickness of the passivation film 5 is selected to be preferably in a range of from 0.1 μm to 100 μm, more preferably in a range of from 0.5 μm to 10 μm. If the distance between the organic light-emitting functional layer 3 and the color filter 6 is too long, lowering of contrast such as color blurring occurs. If the thickness of the passivation film 5 is not kept sufficient, lowering of sealability occurs.

It does not matter whether the material of the passivation film 5 is inorganic or organic. Examples of the inorganic material of the passivation film 5 include: nitride such as SiN, AlN or GaN; oxide such as SiO, Al₂O₃, Ta₂O₅, ZnO or GeO; oxide-nitride such as SiON; carbide-nitride such as SiCN; metal fluoride compounds; and metal films. Examples of the organic material of the passivation film 5 include: epoxy resin; acrylic resin; poly-para-xylene; fluorine high-molecular compounds (such as perfluoroolefin, perfluoroether, tetrafluoroethylene, chlorotrifluoroethylene and dichlorodifluoroethylene); metal alkoxide (such as CH₃OM and C₂H₅OM); polyimide precursors; and perylene compounds.

The passivation film 5 may have a laminate structure such as a laminate structure composed of two or more substances containing silicon nitride oxide; a laminate structure composed of an inorganic protective film, a silane coupling layer and a resin sealing film; a laminate structure composed of a barrier layer of an inorganic material and a cover layer of an organic material; a laminate structure composed of an inorganic substance and a compound of an organic substance and a metal or semiconductor such as Si—CXHY; a structure in which inorganic films and organic films are laminated alternately; or a structure in which SiO₂ or Si₃N₄ is laminated on an Si layer.

A physical vapor phase deposition method or a chemical vapor phase deposition method can be used as a method for forming the passivation film 5. Specific examples of the physical vapor phase deposition method include a resistance heating vacuum vapor deposition method, an electron beam heating vacuum vapor deposition method, a high-frequency induction heating vacuum vapor deposition method, a vapor deposition polymerization method, a plasma vapor deposition method, a molecular beam epitaxy method, a cluster ion beam method, an ion plating method, a plasma polymerization method, and a sputtering method. Specific examples of the chemical vapor phase deposition method include a plasma CVD method, a laser CVD method, a thermal CVD method, and a gas source CVD method. The deposition method can be selected in consideration of the material, etc. of the passivation film.

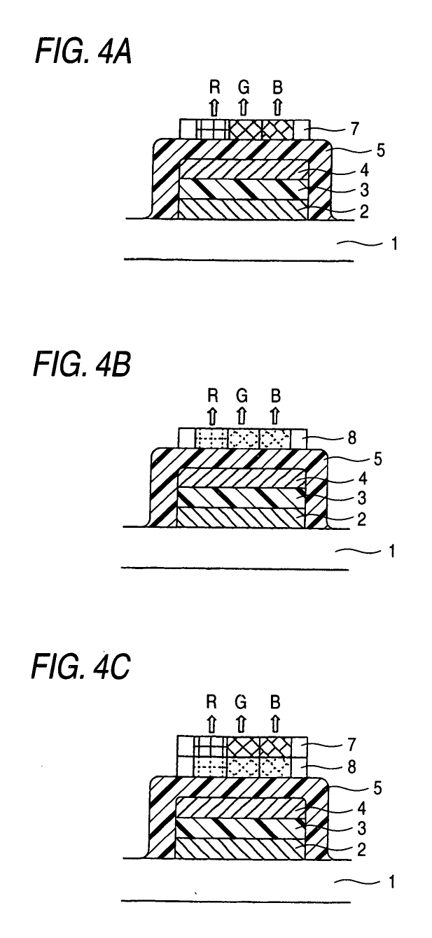

As shown in FIGS. 4A to 4C, the color filter 6 may be formed as a single layer of a color filter layer 7 or a fluorescent color conversion layer 8 above the passivation film 5 or may be formed as a laminate of the fluorescent color conversion layer 8 and the color filter layer 7 above the passivation film 5. When the color filter layer 7 or the fluorescent color conversion layer 8 is formed above the passivation film 5 as shown in FIG. 4A or 4B, reflection of external light can be prevented. As shown in FIG. 4C, the color filter layer 7 may be provided above the fluorescent color conversion layer 8 so that RGB of the color filter 7 correspond to RGB of the fluorescent color conversion layer 8. According to this configuration, the problem of generation of fluorescence in the fluorescent color conversion layer 8 excited by external light can be avoided though the problem is considered as one of causes of lowering of contrast in display.

The color filter layer 7 can be deposited/formed by a method such as a dyeing method in which a dyeing base material such as gelatin, glue, or polyvinyl alcohol having photosensitivity given by dichromate treatment is formed by etching or by use of a color resist; a pigment dispersion method in which a colored resin obtained by dispersing a pigment into a resin such as a polyimide resin is formed by etching or a colored resin obtained by dispersing a pigment into an ultraviolet-curable resin (negative resist) such as an acrylic/epoxy resin or photo-crosslinkable polyvinyl alcohol is formed by use of a color resist; an electro-deposition method in which a pigment is dispersed into an anionic resin such as a polyester resin or a melanin resin dissolved in an electrolytic solvent and is electrochemically precipitated (electro-deposited); or a printing method in which printing is performed with RGB ink obtained by preparing a pigment, oleic acid or stearic acid, phenol, alcohol and an additive (for promoting drying or adjusting viscosity).

The fluorescent color conversion layer 8 has a function for absorbing light such as near-ultraviolet light, blue light, blue-green light or white light emitted from the organic light-emitting functional layer 3 and generating fluorescence in a visible light ranging from blue or blue-green to red. Although examples of the fluorescent material used in the fluorescent color conversion layer 8 will be described below, no particular limitation is placed if the fluorescent color conversion layer 8 has the aforementioned function. Examples of the fluorescent material for receiving near-ultraviolet light from the organic light-emitting functional layer 3 and generating blue fluorescence include Bis-MSB (1,4-bis(2-methylstyryl)benzene), DPS (trans-4,4′-diphenylstilbenezene), and coumarin-4 (7-hydroxy-4-methylcoumarin). Examples of the fluorescent material for receiving blue light emitted from the organic light-emitting functional layer 3 and generating green fluorescence include coumarin-153 (2,3,5,6-1H,4H-tetrahydro-8-trifluormethylquinolizino (9,9a,1-gh)coumarin), coumarin-6 (3-2′-benzothiazolyl)-7-diethylaminocoumarin), and coumarin-7 (3-2′-benzimidazolyl)-7-N,N-diethylaminocoumarin). Examples of the fluorescent material for receiving blue-green light emitted from the organic light-emitting functional layer 3 and generating red fluorescence include DCM (4-dicyanomethylene-2-methyl-6-(p-dimethylaminostyryl)-4H-pyran), pyridine-1 (1-ethyl-2-(4-(p-dimethylaminophenyl)-1,3-butadienyl)-pyri dinium-percholalate), and rhodamine pigments. The fluorescent material, the resin or the like listed above by way of example, preferably a transparent photo resist (photosensitive resin) containing the fluorescent material is deposited on the passivation film 5 by vapor deposition or sputtering or by photolithography or the like in the same manner as in the formation of the color filter layer 7 to thereby form the fluorescent color conversion layer 8.

Although this embodiment has been described on a full color organic EL device using three primary colors of RGB, the invention is not limited thereto but may be also applied to display using two colors or a plurality of colors such as four colors. The display area and display shape of each pixel in RGB are not particularly limited but may be changed suitably in terms of design.

The color filter 6 may be formed as a film above the passivation film 5 by coating. In this manner, the thickness of the color filter 6 can be selected to be not larger than 100 μm, so that a thinner panel can be produced. Because the color filter 6 is provided as a film, the panel can be produced easily by a simple operation of putting the color filter 6 on the passivation film 5.

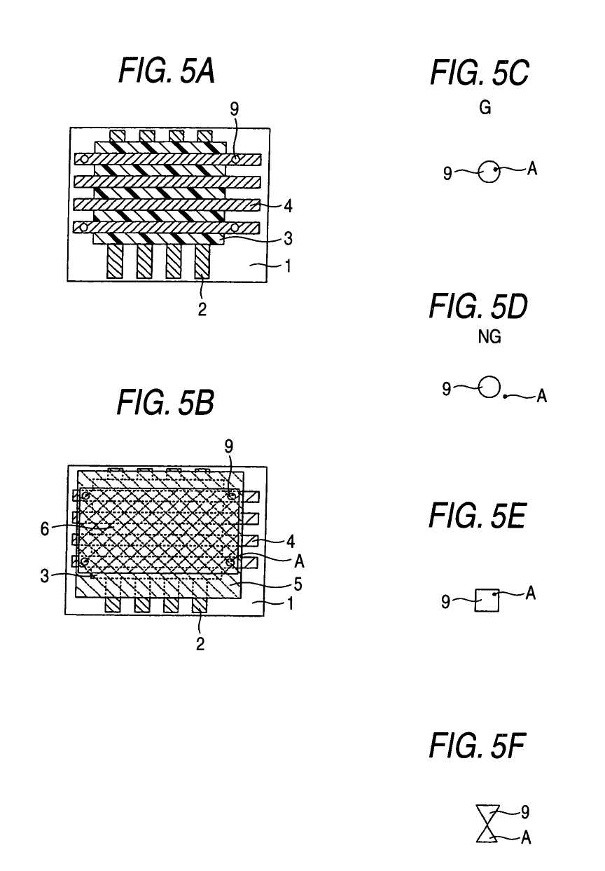

Specifically, as shown in FIG. 5A, alignment spots 9 of the color filter 6 are marked on the upper electrode 4. Then, as shown in FIG. 5B, after the formation of the passivation film 5, the color filter 6 is put on the passivation film 5 so that alignment spots A provided on the color filter 6 are overlapped with the alignment spots 9. FIG. 5C shows a state in which overlapping of the alignment spots 9 and A is correct. FIG. 5D shows a state in which overlapping of the alignment spots 9 and A is incorrect. FIGS. 5E and 5F show other examples of the shapes of the alignment spots 9 and A. The shapes of the alignment spots 9 and A are not limited thereto. Any other shapes may be used if alignment can be made. Although the description has been made on the case where the alignment spots 9 are marked on the upper electrode 4, the invention is not limited thereto. For example, alignment spots may be marked on the substrate 1 or the lower electrode 2.

According to the first embodiment, because the organic light-emitting functional layer 3 is sealed with the passivation film 5, the organic EL device can be provided thinly compared with JP-A-11-339968 or JP-A-2000-195670 using the sealing substrate 240. Moreover, because the color filter 6 is provided on the passivation film 5 provided as a thin film, the distance between the organic light-emitting functional layer 3 and the color filter 6 can be set to be short, so that contrast can be enhanced compared with JP-A-11-339968.

### Second Embodiment

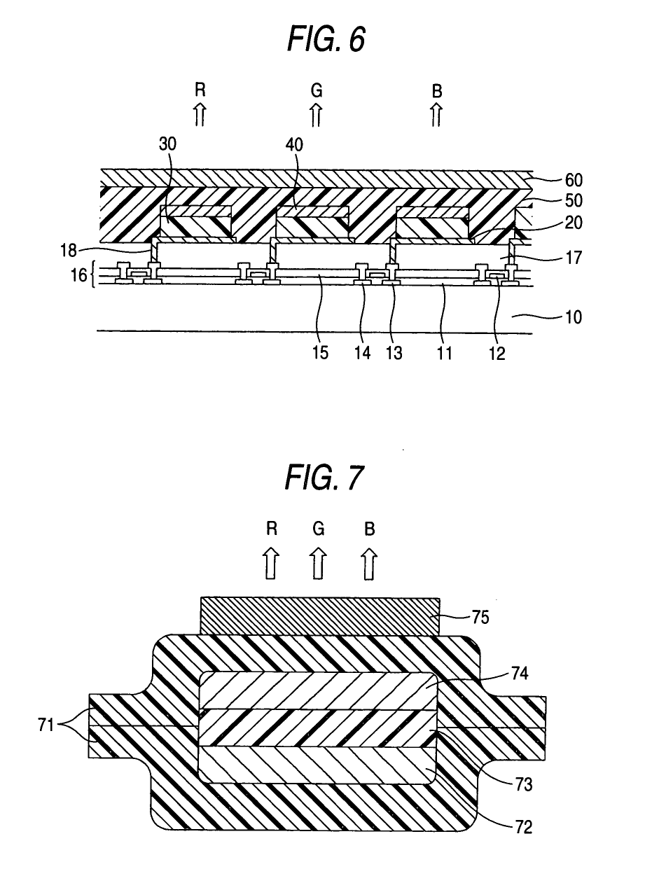

A second embodiment of the invention will be described with reference to FIG. 6. TFTs 16, which are composed of a gate electrically insulating film 11, gate electrodes 12, drain electrodes 13, source electrodes 14 and an interlayer electrically insulating layer 15, are put above a substrate 10. The TFTs 16 are covered with a flattening layer 17 for flattening irregularities in the TFTs 16. The drain electrodes 13 are electrically connected to lower electrodes (pixel electrodes) 20 through contact holes 18 respectively in the fattening layer 17. Organic light-emitting functional layers 30 and upper electrodes 40 are laminated on the lower electrodes 20 respectively. The lower electrodes 20, the organic light-emitting functional layers 30 and the upper electrodes 40 are covered and sealed with a passivation film 50. A color filter 60 is provided on the passivation film 50 so that components of the color filter 60 are located in positions corresponding to pixel portions for emitting light. Although the method for producing the organic EL device according to this embodiment will be described below in brief, the invention is not limited to the following method but the producing method does not matter particularly if the aforementioned configuration can be provided.

Ap-Si film is formed on the substrate 10 by laser annealing. After the p-Si film is patterned by an ultraviolet excimer laser beam, silicon nitride or the -like is deposited by a CVD method to thereby form the gate electrically insulating film 11. Then, a material film of a polyside structure constituted by a laminate of a polysilicon film deposited by a CVD method and a metal silicide film deposited by a sputtering or CVD method is patterned by etching while masked with a resist pattern formed by lithography, to thereby form the gate electrodes 12.

After the gate electrodes 12 are formed, impurities are injected by an ion doping method to thereby form the drain electrodes 13 and the source electrodes 14. Then, a silicon oxide material such as silicon oxide is formed so-that the gate electrodes 12, the drain electrodes 13 and the source electrodes 14 are covered with the silicon oxide material. In this manner, the interlayer electrically insulating layer 15 is formed above the substrate 10.

Then, photosensitive polyimide is applied on the TFTs 16 by a spin coating method to thereby form the flattening layer 17 for flattening the irregularities in the TFTs 16. Further, the flattening layer 17 is subjected to pattern exposure to make exposed portions of the flattening layer 17 soluble in a developing solution. The flattening layer 17 is developed by a rotary spray developing unit so that the exposed portions of the flattening layer 17 are dissolved in the developing solution so as to be removed. In this manner, the contact holes 18 are formed.

After the flattening layer 17 and the contact holes 18 are formed as described above, the lower electrodes 20 are patterned by sputtering so as to be electrically connected to the drain electrodes 13 respectively. An organic EL device is formed on each of the lower electrodes 20 in the same manner as in the first embodiment.

According to the second embodiment, because configuration is made so that light is emitted from a surface opposite to the substrate 10, the design of the TFTs 16 can be performed freely so that light from the organic light-emitting functional layers 30 can be emitted to the outside efficiently. In addition to the effect of the first embodiment, the second embodiment is effective in improving numerical aperture.

### Third Embodiment

A third embodiment of the invention will be described with reference to FIG. 7. An organic EL device includes a lower electrode 72, an organic light-emitting functional layer 73, and an upper electrode 74 in a state in which the lower electrode 72, the organic light-emitting functional layer 73 and the upper electrode 74 are sandwiched between two pieces of a passivation film passivation film 71. A color filter 75 is set by alignment in the same manner as in the first embodiment. On this occasion, each of the lower electrode 72, the organic light-emitting functional layer 73, the upper electrode 74 and the color filter 75 can be formed of the same material by the same method as in the first embodiment. In the third embodiment, the lower electrode 72 and the upper electrode 74 maybe arranged in reverse configuration.

The passivation film 71 is made of a transparent plastic film or the like. Specifically, a film of polyethylene terephthalate, polyethylene-2,6-naphthalate, polycarbonate, polysulfone, polyether-sulfone, polyether-ether-ketone, fluororesin, or polypropylene can be used as the plastic film. The thickness of the plastic film is selected to be preferably in a range of from 1 μm to 1000 μm, more preferably in a range of from 1 μm to 50 μm. If the distance between the organic light-emitting functional layer 73 and the color filter 75 is too large, lowering of contrast such as color blurring occurs. If the thickness of the passivation film 71 is not kept sufficient, lowering of sealability occurs.

An inorganic substance, e.g., silicon oxide such as SiO₂ or metal fluoride, may be deposited on a surface of the plastic film by a vacuum thin-film forming method such as vacuum vapor deposition, ion plating or sputtering in order to improve gas barrier characteristic and water vapor barrier characteristic.

Although FIG. 7 shows the case where the passivation film 71 is made of a single material, the invention may be also applied to the case where pieces of the passivation film 71 are made of different materials if the piece of the passivation film 71 at least on the color filter 75 side is transparent. Two pieces of the passivation film 71 between which the organic EL device is sandwiched may be bonded using an adhesive agent (not shown) such as an urethane adhesive agent, an acrylic adhesive agent, an epoxy resin adhesive agent or an epoxy-amine adhesive agent. At least one of the two pieces of the passivation film 71 may be made of a hot-melt plastic such as polyethylene, polyurethane, polystyrene or polypropylene so that the two pieces of the passivation film 71 can be stuck to each other.

According to the third embodiment, because configuration is made so that the organic EL device is sandwiched between two pieces of the passivation films s 71, the organic EL device can be provided as a flexible thin device in addition to the effects of the first and second embodiments.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An organic EL device comprising:
a lower electrode;
an upper electrode;
an organic light-emitting functional layer provided between the lower and upper electrodes and containing at least a light-emitting layer;
a transparent passivation film for sealing the lower and upper electrodes and the organic light-emitting functional layer; and
a color filter provided above the passivation film.

2. An organic EL device comprising:
a substrate;
a lower electrode provided on the substrate;
an upper electrode;
an organic light-emitting functional layer provided between the lower and upper electrodes and containing at least a light-emitting layer;
a transparent passivation film for sealing the lower and upper electrodes and the organic light-emitting functional layer; and
a color filter provided above the passivation film,
wherein light is extracted from a surface opposite to the substrate.

3. The organic EL device according to claim 1, wherein the color filter is laminated above the passivation film.

4. The organic EL device according to claim 1, wherein the color filter is formed as a film on the passivation film so that the passivation film is coated with the color filter.

5. The organic EL device according to a claim 1, wherein the passivation film comprises a laminate of a plurality of sealing layers.

6. The organic EL device according to claim 1, wherein the passivation film is formed as a film.

7. The organic EL device according to claim 1, further comprising a thin-film transistor formed above the substrate, wherein the organic light-emitting functional layer is provided above the thin-film transistor.

8. A method of producing an organic EL device comprising:
sealing the organic EL device with a transparent passivation film; and
providing a color filter above the passivation film.

9. The method of producing an organic EL device according to claim 8, wherein the organic EL device includes a lower electrode, an upper electrode, and an organic light-emitting functional layer provided between the lower and upper electrodes and containing at least a light-emitting layer.

10. The method of producing an organic EL device according to claim 9, wherein the organic EL device includes a substrate, a lower electrode provided above the substrate.

11. The method of producing an organic EL device according to claim 8, further comprising laminating a color filter above the passivation film.

12. The method of producing an organic EL device according to-claim 8, wherein the color filter is formed as a film on the passivation film so that the passivation film is coated with the color filter.

13. The method of producing an organic EL device according to claim 8, wherein the passivation film comprises a laminate of a plurality of sealing layers.

14. The method of producing an organic EL device according to claim 8, wherein the passivation film is formed as a film.

15. The method of producing an organic EL device according to claim 8, further comprising providing a organic light-emitting functional layer on a thin-film transistor formed above a substrate.
